(19) United States
(12) Patent Application Publication
(10) Pub. No.: US 2010/0085429 A1
(43) Pub. Date: Apr. 8, 2010

(54) ANALYTICAL DEVICE FOR THE OPTICAL ANALYSIS OF A MEDIUM BY MEANS OF AT LEAST ONE IMAGING DEVICE

(76) Inventors: Jorgensen Terje, Skien (NO); Reinhold Frode, Skien (NO); Norbert Scholz, Habloch (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/597,617

(22) PCT Filed: Apr. 10, 2008
(86) PCT No.: PCT/EP08/02819

§ 371 Date: Dec. 4, 2009

(30) Foreign Application Priority Data
Apr. 26, 2007 (DE) 10 2007 020 149.6

(51) Int. Cl. H04N 7/18

(52) U.S. Cl. 348/135; 348/E07.085

(57) ABSTRACT

The invention relates to an analysis device for optical analysis of a medium by means of at least one imaging apparatus (3), the analysis device comprising at least one sample carrier (6, 8), and in that the sample carrier (6, 8) and/or the at least one imaging apparatus (2) can be pivoted or rotated by means of at least one drive mechanism.

The present invention relates to an analysis device for optical analysis of a medium by means of at least one imaging apparatus. The device, which can also be called an imaging measuring device, is used to determine characteristic data of disperse systems, such as size, shape, colour, number and concentration, which may be available in isolated form, concentrated form or in the form of compact samples or images.

The invention relates in particular to a measuring device with a modular construction which can be used offline, online or even inline depending on requirements. The use of adapted optical components and sample preparation and transportation modules means it is possible to process dry and liquid samples, also in compact form (for example sections), or images.

In many chemical and process-engineering processes production is controlled, primarily for safety reasons, using the typical measured variables, such as temperature, pressure, viscosity, throughput, etc. Increasingly more stringent product quality requirements and demands for increases in output that result for financial reasons have also lead to the development and use of special measuring methods that are capable of evaluating the produced material in terms of its chemical and physical quality. Mechanical and optical methods which provide information on, for example, concentrations and size distributions dare used here, in particular with “offline” applications that accompany production. A further improvement in data reliability and data quality has been achieved through the use of image-processing measuring methods. Furious developments in the field of computers, data processing, cameras and light sources have lead to image processing being used directly or indirectly, and to a significantly increasing extent, in many production processes. In addition to said integral information from a process, image-processing methods provide additional results on shape, colour, number and concentration. As what is involved here is an integrating method, the results are available not only to the collective but can also be associated with any object (for example particles).

In addition to the classifying and optical extinction or scattered light methods image-processing methods are also used specifically in the field of production control and quality management of disperse products. Measuring devices are known which are used in the laboratory but also online or inline in production methods. Different preparation methods, mechanical and optical components, such as conveying mechanisms, agitators, ultrasonic dispersers, flow cells, lenses, cameras, microscopes, optical fibres, light sources, etc. are used depending on the size and condition of the samples to be evaluated.

The above-described, image-processing methods have several drawbacks. For example, known measuring devices are designed for the respective application and can only be used in very narrow applicability and measuring range limits. For evaluating microscopically small materials for example normal or inverse microscopes with different lenses and lighting systems are typically used which only allow shallow working depths, small observation plots and small operating distances and therefore little play for different types of sample preparation and sample transportation. Other devices allow only the processing of dry materials or materials dispersed in liquid, or are optimised for stationary materials or materials that are moving. The known methods are often shock-sensitive and insufficiently robust and flexible for operational use.

The object of the present invention is therefore the provision of a universal, robust image-processing analysis and measuring device with a modular construction which with the simplest means allows adaptation to very wide applicability and measuring range limits.

This object is achieved according to the invention by a measuring device with the features of claim 1. Advantageous embodiments of the measuring device emerge from the features of sub-claims 2 to 30. A method for the analysis of a sample by means of the analysis device according to any one of claims 1 to 29 is claimed by means of claims 31 to 33.

By using an arbitrarily dimensionable, central stand with a holding device that can be pivoted, and in particular about 360 degrees, for cameras, lenses, light sources and/or sample carriers or sample guides it is possible to cover a very wide range of measuring tasks and ranges. The domain of sample guiding is also critically important here to the sharpness of the optical components used. The use for example of glass plates, flow cells, reactors, cross tables, mechanical, hydraulic and pneumatic sample transportation systems, as well as image and sample holders which can be adapted to the respective problem definition in the pivotal range from 0 to 360 degrees is provided for this domain. Sample preparation can be carried out in modules with different designs and which can be coupled to or arranged on the central stand. Fully automatic operation and incorporation in online applications is possible by using robotics and process-engineering components, such as automatic sample feeding and sampling. The entire measuring device, including modular sample preparation modules or parts thereof, can have an open or enclosed construction.

The analysis or measuring device advantageously has a central stand with a base holding device, in particular in the form of a base plate, that can be pivoted, in particular about 1 to 360 degree(s), for determining characteristic data of disperse systems, such as size, shape, colour, number and concentration, which systems are available in isolated form or concentrated form or in the form of compact samples, or images. The at least one sample carrier and/or an imaging apparatus, in particular in the form of a camera, is arranged on this base holding device, which can be rotated or pivoted by a drive mechanism, so as to be fixed or movable. The individual components arranged on the base holding device can be moved by suitable actuators. It is therefore possible to arrange one or more cameras on the base holding device in different arrangements (for example parallel or orthogonal) for taking a photo of the object of interest. A drive unit can be used for example as a Z drive for automatically focussing a camera. It is likewise possible for a plurality of lenses, such as normal, microscopic and telecentric lenses, to be associated with one camera and these can optionally be connected upstream of the camera. Different filters can likewise automatically be connected upstream of the camera.

Constant light sources and flashlight sources with different intensities, wavelengths and pulse times can also be arranged on the base holding device. It is also possible to provide at least one second holding device on the stand which is arranged on the stand so as to be fixed or can also be rotated by means of suitable drives and/or be moveably arranged on the stand. Sample carriers, cameras, feeding systems, light sources, etc. may also be disposed on this additional holding device.

Glass plates, flow cells, reactors, etc. can be used as sample carriers within the meaning of the invention. Therefore the samples carriers can be moved or adjusted, in particular in the object plane, by means of a cross table or suitable mechanically, hydraulically or pneumatically driven sample carrier transportation systems.

Sample carriers, mixing and dispersing devices, transportation systems, such as pumps, vibrating chutes, metering screws, belts or fans, can be arranged on the stand or base holding device.

Sample preparation modules for dispersing, diluting to measuring concentration in the liquid- or gas-borne state, sample or image transportation can also be provided.

It is also possible to provide automatic sampling from a point of interest in the production unit and transportation thereof into a preparation module or directly into the object plane by means of a suitable device.

A data processing system for evaluation, visualisation and storing of the results with interface in a superordinate network completes the analysis device according to the invention.

In an advantageous embodiment of the analysis and measuring device according to the invention it comprises a stand and a pivotal base holding device with the light sources, object plane, lens and camera being arranged on the base holding device. For liquid processing and dispersing of the sample a sample holder with agitator and a hose pump for transporting the suspension are secured to the central stand, the hose pump feeding the sample by means of pump and hose—or in the case of particularly critical samples by gravity alone—to a sample carrier holding device with integrated sample distributor. A transparent or an opaque sample plate can be used as the sample carrier. The sample carrier holding device receives the sample plate which can be easily replaced, very easily cleaned and is oriented in the object plane, and transports the suspension to be measured through the object plane at an angle of inclination that is easy to adjust. The angle of inclination is predefined by the viscosity and the desired layer thickness of the sample flow.

The, for example, glass plate can advantageously be adapted to the interface properties of the suspension by way of various coatings. Open sample transportation avoids the problems of particle blockades known in closed cells and the minimum layer thicknesses predefined by the largest particles which cause great problems with the depth of field range. Automatic control of the sample flow in continuous or “stop and go” technology and a controlled light source with automatic threshold setting for the contrast transition makes it possible to measure even very highly concentrated samples. Basically the circular operation Mode and passage operation mode may be used in the case of sample transportation.

The measuring device advantageously comprises constant, pulsed and/or triggered light sources with different wavelengths, intensities and propagation directions. The light is emitted for example in incident light, transmitted light, bright field or dark field and in different directions and combined with adapted lenses, such as normal, microscope or telecentric lenses, provides for sharp and high-contrast imaging of the sample in one or more, preferably digital, black and white or colour cameras used. The required resolution, sensitivity and speed of exposure can be varied within wide limits as a function of the problem definition. Thus, for example, real-time processing of more than 25 images per second is possible with a “one million pixel camera”, a pulsed light source (typical flash units, laser or light-emitting diodes) in preferably the 500 ns to 60 μs range and a specially developed image evaluation unit.

Further preferred embodiments use external, manual, automatic or robotics-controlled and regulated sampling and sample preparation modules that can be coupled to the central stand, the modules containing a representative sampling, sample transportation, preparation steps such as division, wetting, dilution and dispersing. Mechanical components, such as vibrating conveying chutes, worms, belts or robotics systems, as well as pneumatic and hydraulic mechanisms using for example fans or pumps, are used for the transportation of dry and liquid samples.

Also installed in the object plane are simple or temperature-controlled reactors for example which, with or without the incorporation of peripheral processing techniques—such as precipitation, crystallisation, swelling, etc.—can be observed in terms of image analysis and be metrologically detected. It is important in this connection that the holding device, which can be pivoted through 360 degrees and includes the light sources, object planes, lenses and cameras, can transmit a targeted movement and change in position to the sample. With different chemical and process-engineering boundary conditions in each position continuous observation and image processing is thereby possible with any desired angles of arrangement from “horizontal normal” (sample is arranged between camera and object carrier), via “vertical” to “horizontal inverse” (camera takes image of the sample through the object carrier).

Simple or automatically operated xy cross tables, sample holders and image transportation and film reel mechanisms can be installed in the pivotal holding device for the metrological processing of simply prepared samples, pictographic originals and compact samples, for example in the form of sections or micrographs.

For all described applications it holds that the sharpness is manually or automatically adjusted, preferably in the z axis using lens and camera. Calibration and control measurements can be carried out manually or automatically using for example disperse materials, reticles or pictographic originals.

A preferred embodiment will be described in more detail with reference to the figures, in which:

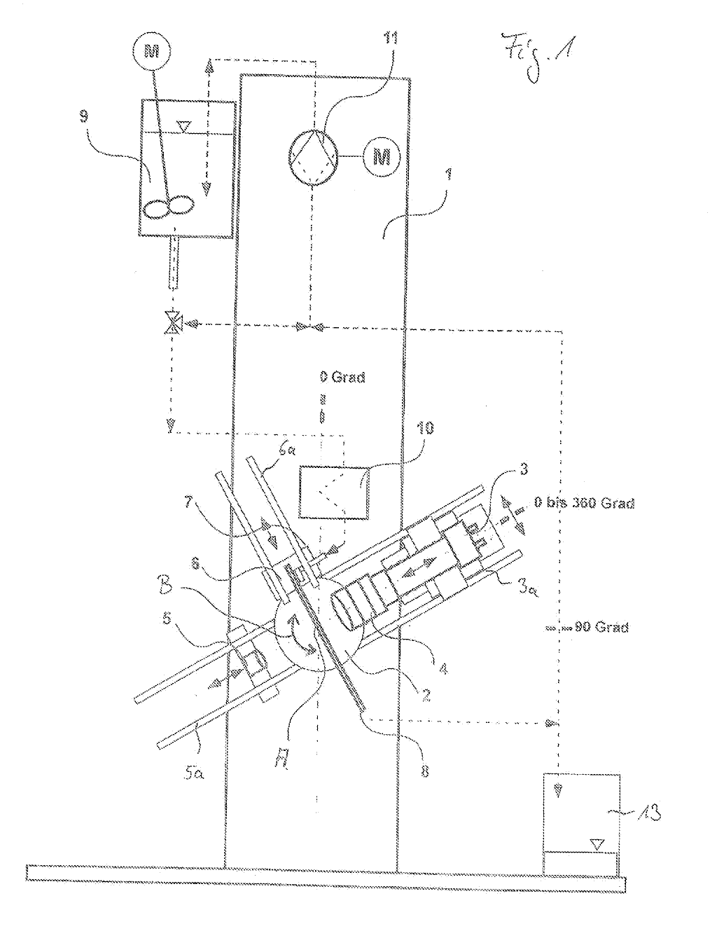

FIG. 1: shows an analysis device according to the invention,

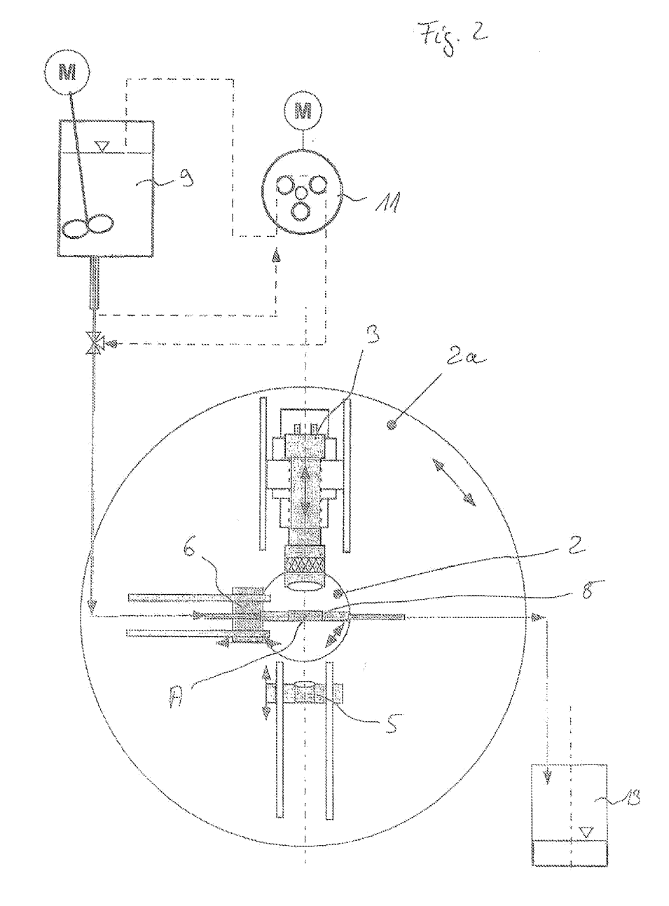

FIG. 2 shows an alternative embodiment with two holding devices rotatably mounted on the stand in the position “horizontal normal”,

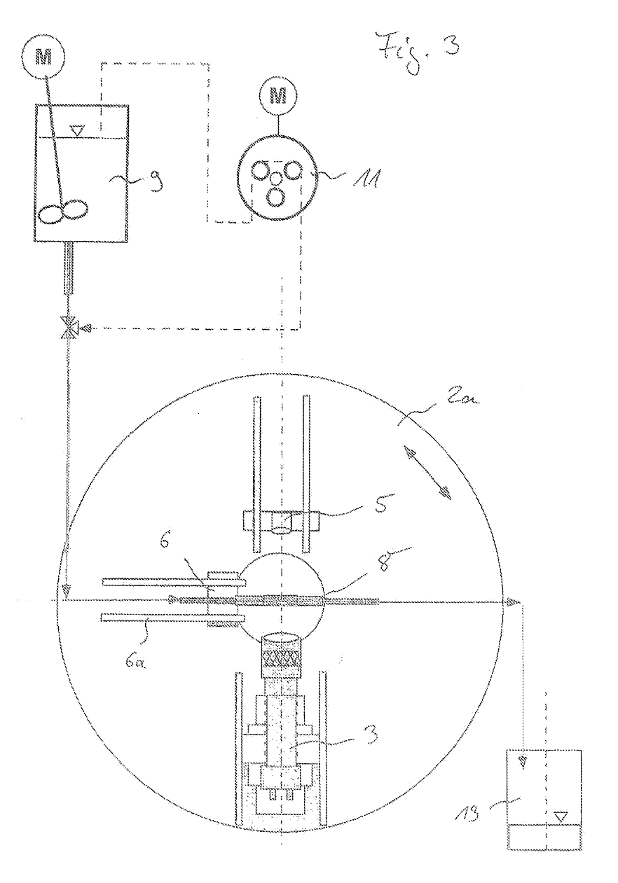

FIG. 3 shows an embodiment according to FIG. 2 in the position “horizontal inverse”.

FIG. 1 shows a first possible position of the base holding device 2 which is arranged on the central part of the measuring device so as to be rotatable about axis A by means of a drive (not shown), the central part being constructed as a stable stand 1. A camera 3, lens 4, the light source 5 and sample carrier holder 6 are arranged on the base holding device 2 which can be pivoted about 360 degrees. Both camera 3 and light source 5 are longitudinally displaceably mounted on guide rails 3a, 5a and can move by means of drives (not shown).

The positions of the listed components can change in any direction, preferably in the optical axis.

The sample carrier holder 6 with integrated sample distributor 7 is used to feed samples into the measuring plane, i.e. onto the transparent or opaque plate 8 (sample carrier) secured in the holder, which can have different coatings to adapt to the interface properties. The sample holder 6 comprises guides 6a along which the sample carrier 8 is displaceably guided.

An agitated vessel 9 equipped with different agitators and/or ultrasonic sonotrodes, and/or a dispersing module 10 coupled to the sample distributor is provided for sample preparation.

Sample transportation from sample receptacle into the measuring or object plane takes place for example as a result of gravity or by means of a pump 11 suitable for the sample.

The above-described analysis device can also have additional components, such as additional cameras in a different arrangement (for example parallel or orthogonal) for taking images of the objects of interest. Automatic, for example software-controlled, focusing can take place, moreover, wherein suitable actuators for the camera are to be provided for this purpose.

Similarly microscopic or telecentric lenses may also be used in addition to normal ones, and these can either be manually arranged upstream of the camera, or automatically, for example by means of a revolver mechanism. A wide variety of filters can likewise be connected upstream, in particular automatically, as a camera attachment. Constant and flashlight sources with different intensities, wavelengths, pulse times and directions can moreover be arranged on the holding device 2 or lens 4.

Sample preparation modules for dispersing, dilution to measuring concentration in the liquid- or gas-borne state, sample or image transportation can either be arranged on the stand 1, the holding device 2 or next to the analysis device.

It is likewise possible to provide a cleaning system which cleans the sample carrier 8 after each analysis operation or at predefined intervals. The cleaning device can be arranged at least partially on the base holding device 2 and therefore follows the movements of the sample carrier 8. It is equally possible to arrange the sample carrier on the base holding device so it is displaceable, it being possible for an actuator to move the sample carrier past a cleaning system.

The sample taken from the production process and that is to be analysed passes as a result of gravity or conveying systems (not shown) from the sample carrier 8 into the receiving container 13 and can optionally be fed to the production process again.

FIG. 2 shows an alternative embodiment with two holding devices 2, 2a rotatably mounted on the stand, the sample holder 6 being displaceably arranged on the first base holding device 2 and the camera 3 and the lighting 5 being displaceably arranged on the second holding device 2a. Both holding devices 2, 2a can be rotated about axis A independently of one another by means of drives (not shown). It is hereby possible to position the sample in a wide variety of positions relative to the camera 3. In the illustrated position the camera 3 is arranged above the sample carrier 8, whereby the sample is situated between sample carrier 8 and camera 3 (“horizontal normal”).

FIG. 3 shows an arrangement in which the camera 3 is arranged below the sample carrier 8, so the photo is taken through the glass of the sample carrier (“horizontal inverse”).

1. An analysis device for optical analysis of a medium by means of at least one imaging apparatus, wherein the analysis device comprises at least one sample carrier, and wherein the sample carrier and/or the at least one imaging apparatus can be pivoted or rotated by means of at least one drive mechanism.

2. The analysis device according to claim 1, wherein the sample carrier comprises a plate.

3. The analysis device according to claim 1, wherein the sample carrier comprises at least one region, which is the receiving region of at least one imaging apparatus.

4. The analysis device according to claim 1, wherein the sample carrier comprises an entry region and an exit region, a medium to be analyzed arriving on or at the entry region of the sample carrier by means of a feeding system.

5. The analysis device according to claim 4, wherein the medium passes from the sample carrier owing to gravity or by means of a transportation or cleaning device, via the exit region.

6. The analysis device according to claim 1, wherein the sample carrier comprises at least one reservoir for at least one substance.

7. The analysis device according to claim 6, wherein by pivoting at least the sample carrier a substance or the medium to be analyzed can be conveyed from a reservoir to at least one receiving region.

8. The analysis device according to claim 1, wherein the receiving region is also a region in which at least two substances react or can be mixed or blended with each other.

9. The analysis device according to claim 1, wherein the at least one imaging apparatus is a CCD camera, at least one lens being associated with the camera.

10. The analysis device according to claim 1, wherein at least one feeding system automatically continuously or discontinuously feeds a medium to be analyzed to the sample carrier.

11. The analysis device according to claim 1, wherein the analysis device comprises a controller which controls the movement of the sample carrier and the imaging apparatus.

12. The analysis device according to claim 1, wherein the imaging apparatus can be moved relative to the sample carrier by means of at least one drive.

13. The analysis device according to claim 1, wherein the at least one imaging apparatus can optionally be arranged above or below the sample carrier for analysis of the medium to be analyzed located on or in the sample carrier.

14. The analysis device according to claim 1, wherein the analysis device comprises at least one lighting source which is stationarily arranged or can be pivoted by means of its own drive or the drive of the sample carrier.

15. The analysis device according to claim 1, wherein at least one feeding system can be pivoted together with the sample carrier by a drive.

16. The analysis device according to claim 1, wherein the at least one sample carrier can be pivoted or rotated about the sample carrier axis through at least 180 degrees.

17. The analysis device according to claim 1, wherein the analysis device comprises a central stand to which the at least one sample carrier and the at least one imaging apparatus are pivotally or rotatably attached.

18. The analysis device according to claim 17, wherein a base holding device is rotatably attached to the stand and can be rotated by means of a drive mechanism, at least the at least one sample carrier being arranged on the base holding device.

19. The analysis device according to claim 18, wherein the at least one imaging apparatus is also arranged on the base holding device.

20. The analysis device according to claim 18, wherein the at least one sample carrier and/or the at least one imaging apparatus is/are displaceably mounted by means of a drive in each case.

21. The analysis device according to claim 20, wherein the at least one sample carrier and/or the at least one imaging apparatus is/are arranged on a cross table, one drive being provided for one axis respectively.

22. The analysis device according to claim 1, wherein the sample carrier is a glass plate, a glass cell, a flow tube, or a reactor.

23. The analysis device according to claim 1, wherein the analysis device comprises a sample holder for a sample carrier and this holds the sample carrier in the receiving region of the at least one imaging apparatus and/or feeds it to the receiving region.

24. The analysis device according to claim 1, wherein the analysis device comprises a sample carrier transportation system with which at least one sample carrier can be successively fed to the receiving region of an imaging apparatus.

25. The analysis device according to claim 1, wherein the analysis device comprises a sample preparation unit in which the medium to be analyzed is mechanically and/or chemically prepared for analysis.

26. The analysis device according to claim 1, wherein the analysis device comprises various sample carriers that allow analysis of various substances and various analysis methods, the controller of the analysis device selecting the sample carrier required in each case and providing it for analysis by means of a transportation system.

27. The analysis device according to claim 1, wherein the analysis device comprises a cooling and/or heating device, by means of which the substance or sample to be analyzed can be cooled and/or heated to a predefinable temperature.

28. The analysis device according to claim 27, wherein the cooling and/or heating device is arranged on the sample carrier or a base plate.

29. Analysis device according to claim 1, wherein the at least one imaging apparatus can be moved around the at least one sample carrier, the sample carrier being pivoted about its axis with the imaging apparatus or dwelling in one position.

30. The analysis device according to claim 1, wherein the axis of rotation of the base holding device is arranged in the plane of the sample carrier.

31. A method for analysis of a sample using an analysis device according to claim 1, wherein a substance or sample to be analyzed is fed by means of the feeding system to the at least one sample carrier and the at least one sample carrier is pivoted by means of the drive mechanism into a specific position in which the at least one imaging apparatus creates at least one image of the sample and transfers it to a data processing unit for further processing.

32. The method according to claim 31, wherein, depending on the required analysis method, the at least one imaging apparatus generates images of the substance or sample to be analyzed from the side of the sample carrier, from above the sample carrier or from below the sample carrier.

33. The method according to claim 31, wherein during the analysis procedure the sample carrier moves alone or together with the at least one imaging apparatus, and is pivoted about an axis, and the imaging apparatus generates images during and/or between pivoting for further evaluation.
